(19) United States
(12) Patent Application Publication
(10) Pub. No.: US 2001/0051219 A1
(43) Pub. Date: Dec. 13, 2001

(54) Rotational casting method for coating a flexible substrate and resulting coated flexible article

(76) Inventors: Thomas H. Peter, Southbury, CT (US); Vincent J. Gajewski, Cheshire, CT (US); Andrew Clock, Southington, CT (US)

Correspondence Address: MICHAEL E. CARMEN, ESQ., DILWORTH & BARRESE, LLP, 333 Earle Ovington Blvd., Uniondale, NY, 11553, US

(21) Appl. No.: 09/904,086

(22) Filed: Jul. 12, 2001

Related U.S. Application Data
(62) Division of application No. 09/535,218, filed on Mar. 27, 2000.

(51) Int. Cl. B05D 3/02

(52) U.S. Cl. 427/385.5

(57) ABSTRACT

A method for rotationally casting a coating onto a flexible substrate is provided wherein the coating comprises a polyurethane composition formed from (a) a substantially linear isocyanate-terminated polyurethane prepolymer; and, (b) a curative agent containing a diol having a molecular weight of less than 250 and, optionally, a secondary aliphatic diamine. Also provided is a flexible substrate possessing the coating.

### BACKGROUND OF THE INVENTION

This invention relates to a rotation casting method for coating a flexible substrate and resulting coated flexible article. More particularly, this invention is directed to a rotational casting method for coating a flexible substrate and the resulting coated flexible article wherein the coating includes at least a polyurethane composition formed from (a) a substantially linear isocyanate-terminated polyurethane prepolymer; and, (b) a curative agent containing a low molecular weight diol and, optionally, a secondary aliphatic diamine.

Methods for coating various substrates are known, e.g., conventional casting technique, spray technique, etc. Presently, a rotational casting technique has been employed for coating polyurethane elastomer compositions onto rigid substrates. Several advantages are associated with this method over the other known coating methods. For example, the rotational casting method provides a shorter production time with no requirement for a mold compared to the conventional casting method while also using less materials compared to the spraying method where overspraying generally occurs.

Ruprecht et al., “Roll Covering by Rotational Casting with Fast-Reacting PUR Systems”, Polyurethanes World Congress 1991 (September 24-26) pp. 478-481 describes rotational casting techniques useful for producing roll coverings using fast-reacting polyurethane elastomer systems. In these systems, the polyurethane reaction mixture is metered through a movable mixing head which travels at constant speed in the axial direction along the rotating roll core, a short distance above its surface. The polyurethane reaction mixture solidifies very quickly in a matter of seconds, to produce a polyurethane coating with a thickness buildup of 4-5 mm. Additional layers of the polyurethane reaction mixture are applied until the desired thickness of polyurethane coating is achieved.

U.S. Pat. No. 5,895,806 discloses a polyurethane composition containing dual thixotropic agents and U.S. Pat. No. 5,895,609 discloses a rotational casting method for coating a cylindrical object employing the polyurethane composition of the '806 patent. By employing the polyurethane composition containing dual thixotropic agents, a thicker coating was achieved per each pass without any dripping or ridging. These polyurethane coating compositions have found wide commercial use on rigid substrates, e.g., metals, plastics and composites, in areas such as, for example, paper and steel mill rolls, industrial rolls and graphic art printing rolls.

It would be desirable to provide a rotational casting method for coating a flexible substrate and the resulting flexible substrate possessing a coating formed from a polyurethane composition wherein the coating exhibits high flex fatigue resistance for use in areas of, for example, printing blankets, cutting blankets and belting.

### SUMMARY OF THE INVENTION

In accordance with the present invention, a method for coating a flexible substrate is provided which comprises rotationally casting to the substrate a coating comprising a polyurethane composition formed from (a) a substantially linear isocyanate-terminated polyurethane prepolymer; and, (b) a curative agent containing a diol having a molecular weight of less than about 250 and, optionally, a secondary aliphatic diamine, wherein the polyurethane composition is formed in the absence of a non-linear isocyanate-terminated polyurethane prepolymer.

Further, in accordance with the present invention, a flexible substrate possessing a coating is provided wherein the coating comprises a polyurethane composition formed from (a) a substantially linear isocyanate-terminated polyurethane prepolymer; and, (b) a curative agent containing a diol having a molecular weight of less than about 250 and, optionally, a secondary aliphatic diamine, wherein the polyurethane composition is formed in the absence of a non-linear isocyanate-terminated polyurethane prepolymer.

### DESCRIPTION OF THE PREFERRED EMBODIMENTS

The flexible substrate of this invention possesses a coating applied by rotationally casting the coating to the substrate. The coating of this invention exhibits a flex fatigue resistance ranging from about 25,000 to about 2,000,000 and includes at least a polyurethane composition formed from a substantially linear isocyanate-terminated polyurethane prepolymer and a curative agent, e.g., a low molecular weight diol and, optionally, a secondary aliphatic diamine, wherein the polyurethane composition is formed in the absence of a non-linear isocyanate-terminated polyurethane prepolymer.

For the purpose of this invention, the term “substantially linear isocyanate-terminated polyurethane prepolymer” means a reaction product which is formed when an excess of a difunctional organic diisocyanate monomer is reacted with a difunctional polyol. Preferably, a stoichiometric excess of the diisocyanate monomer (an NCO:OH ratio greater than 2:1) is used.

The organic diisocyanate monomer can be an aromatic or aliphatic diisocyanate. Useful aromatic diisocyanates can include, for example, 2,4-toluene diisocyanate and 2,6-toluene diisocyanate (each generally referred to as TDI), mixtures of the two TDI isomers, 4,4′-diisocyanatodiphenylmethane (MDI), p-phenylenediisocyanate (PPDI), diphenyl-4,4′-diisocyanate, dibenzyl-4,4′-diisocyanate, stilbene-4,4′-diisocyanate, benzophenone-4,4′-diisocyanate, 1,3- and 1,4-xylene diisocyanates, and mixtures thereof. Preferred aromatic isocyanates for preparation of the polyurethane prepolymers of the present invention include MDI and PPDI.

Useful aliphatic diisocyanates can include, for example, 1,6-hexamethylene diisocyanate, 1,3-cyclohexyl diisocyanate, 1,4-cyclohexyl diisocyanate (CHDI), the saturated diphenylmethane diisocyanate (known as H(12)MDI), isophorone diisocyanate (IPDI), and the like. A preferred aliphatic diisocyanate for use herein is CHDI.

High molecular weight (MW) polyols useful in the preparation of the isocyanate-terminated polyurethane prepolymer have a number average molecular weight of at least about 250, e.g., polyether polyols, polyester polyols, etc. The molecular weight of the polyol can be as high as, e.g., about 10,000 or as low as about 250. A molecular weight of about 650 to about 3000 is preferred with a molecular weight of about 2000 being the most preferred.

A preferred high MW polyol is a polyalkyleneether polyol having the general formula HO(RO)ₙH wherein R is an alkylene radical and n is an integer large enough that the polyether polyol has a number average molecular weight of at least about 250. Such polyalkyleneether polyols are well-known and can be prepared by the polymerization of cyclic ethers such as alkylene oxides and glycols, dihydroxyethers, and the like, employing methods known in the art.

Another preferred high MW polyol is a polyester polyol. Polyester polyols can be prepared by reacting dibasic acids (usually adipic acid but other components such as sebacic or phthalic acid may be present) with diols such as ethylene glycol, 1,2 propylene glycol, 1,3 propanediol, 1,4 butylene glycol and diethylene glycol, tetramethylene ether glycol, and the like. Another useful polyester polyol can be obtained by the addition polymerization of e-caprolactone in the presence of an initiator.

Other useful high MW polyols are polycarbonates, e.g., hexamethyleneethylene which is commercially available from Bayer (Leverkusen, Germany), and polyols that have two hydroxyl groups and whose basic backbone is obtained by polymerization or copolymerization of such monomers as butadiene and isoprene monomers.

Particularly preferred polyols useful in the preparation of the isocyanate-terminated polyurethane prepolymer of this invention include polytetramethylene ether glycol (PTMEG), polycarbonates and a dihydroxypolyester.

In general, the substantially linear isocyanate-terminated polyurethane propolymer can be prepared by reacting the organic diisocyanate monomer with the polyol in a mole ratio of organic diisocyanate monomer to polyol ranging from about 1.7:1 to about 12:1, depending on the diisocyanate monomer being used. For example, when the diisocyanate monomer is TDI, the preferred mole ratio of organic diisocyanate monomer to polyol is from about 1.7:1 to about 2.2:1. When the diisocyanate monomer is MDI, the preferred mole ratio of organic diisocyanate monomer to polyol is from about 2.5:1 to about 4:1.

The curative agent of the present invention can be a low molecular weight diol and, optionally, a secondary aliphatic diamine.

The low molecular weight diol for use herein will have an average molecular weight of less than about 250 and preferably less than about 100. Suitable low molecular weight diols include ethylene glycol, 1,2-propylene glycol, 1,3-propanediol, 1,3-butylene glycol, 1,4-butanediol, 2-methyl-1,3-propanediol, 1,5-pentanediol, neopentyl glycol, 1,6-hexanediol, 2-ethyl-2-propyl-1,3-propanediol, cyclohexyldimethanol, cyclohexanediol, hydroquinone di(betahydroxyethyl)ether, resorinor di(betahydroxy)ethyl ether, and the like and mixtures thereof. Preferred diols for use herein are 1,4-butanediol and cyclohexyldimethanol. The amount of diol employed in the curative agent will ordinarily range from about 95 to 100 weight percent and preferably greater than about 98 weight percent, based on the total weight of the curative agent.

Suitable secondary aliphatic diamines for use herein are those having the general formula R₁NHR₂NHR₃ wherein R₁ and R₃ are the same or different and each are alkyl groups having from 1 to about 5 carbon atoms with 1 or 2 carbons being preferred and R₂ is an alkyl group having from 1 to about 6 carbon atoms with 2 carbon atoms being preferred or an alicyclic, e.g., cyclohexyl. Other useful secondary aliphatic diamines are heterocyclics, e.g., piperazine. Preferred secondary aliphatic diamines for use herein are N,N′-dimethylethylenediamine and piperazine with piperazine being more preferred.

The secondary aliphatic diamine is ordinarily mixed with the diol to form the curative agent in an amount ranging from 0 to about 5 weight percent, based on the total weight of curative agent. A more preferred range is from about 0.25 to about 1% weight percent. By employing minor amounts of a secondary aliphatic diamine in the curative agent, it has been discovered that when rotationally casting the coating onto the flexible substrates of this invention the coating will advantageously have a faster cure rate.

If desired, the reaction between the prepolymer and the curative agent to form the polyurethane composition can take place in the presence of a catalyst. Useful catalysts include organometallic compounds such as organotins, e.g., dibutyltin dilaurate, dibutyltin dimercaptide, dibutyltin diacetate, stannus octoate, etc., tertiary amines, e.g., triethylene diamine, triethylamine, n-ethylmorpholine, dimethylcyclohexylamine, 1,8-diazabicyclo-5,4,0-undecene-7, etc., and the like. It is also contemplated that other materials known to one skilled in the art can be present in the curative agent.

The substantially linear isocyanate-terminated polyurethane prepolymer can be mixed with the curative agent in stoichiometric amounts such that the total active hydrogen content of the curative agent is equal to about 90-115% of the total isocyanate content of the isocyanate-terminated prepolymer. In a more preferred embodiment, the total active hydrogen content of the curative agent is equal to 95%-105% of the total isocyanate content of the isocyanate-terminated prepolymer. As the stoichiometric amounts are increased, the flex fatigue properties of the coating used herein will also increase.

In general, when rotationally casting the coating composition to the flexible substrate, the polyurethane composition can be reacted, mixed and applied as a coating to the flexible substrate at ambient temperatures or the composition can be heated to accommodate the requirements of meter mix machines, e.g., temperatures ranging from about 25° C. to about 70° C. Details of the equipment types and process steps used in rotational casting are described in Ruprecht et al., supra. The compositions can be applied to the flexible substrate to be coated without the need for molds. Use of the polyurethane composition as a coating in rotational casting also results in minimal dripping and maximum use of material applied.

The flexible substrates to be coated herein includes fabrics, foams, thin metal sheets and the like. Suitable fabrics include nylon, rayon, polyester, cotton, wool, kevlar, fiberglass and the like and are typically used in, for example, conveyor belts, printing blankets, etc. Suitable foams include polyurethane foams, polyethylene foams, vinyl polymer foams, rubber latex foams, nitrile foams, neoprene foams and the like and are typically used in making, for example, shipfendors, buoys, etc.

The examples that follow detail the coatings of this invention and demonstrate the high flex fatigue resistance by rotational casting the coating within the scope of this invention when compared to coatings outside the scope of this invention that are hot cast or rotationally cast. Details of the equipment types and process step used in rotational casting are described in Ruprecht et al., supra.

The flex fatigue resistance for each test example was measured with a texus flexometer model no.31-11 at 70° C. The test measures cut growth resistance in accordance with ASTM D-3629-78 at a bending angle of 23° and a rotation rate of 500 rpm.

### EXAMPLE 1

### Preparation of a Substantially Linear Isocyanate-Terminated Polyester Prepolymer

A substantially linear isocyanate-terminated polyurethane prepolymer was prepared by reaction 4 moles of MDI with 1 mole of 2500 MW polyester prepared from ethylene glycol and adipic acid for three hours at 80° C. in a 3 neck, 3 liter, round bottom flask equipped with stirrer, nitrogen inlet, heating mantel and temperature controller. The resulting isocyanate content was measured as 7.2% by weight by the dibutylamine method as described in ASTM D1638.

### EXAMPLE 2

### Preparation of a Substantially Linear Isocyanate-Terminated Polyether Prepolymer

A substantially linear isocyanate-terminated polyurethane prepolymer was prepared by reacting 3.8 moles of MDI to 1 mole of 2000 MW PTMEG polyol for 3 hours at 80° C. employing the same equipment as in example 1. The resulting isocyanate content was measured as 8.0%.

### EXAMPLE 3

### Preparation of the Curative Agent

A curative agent was prepared by heating 1,4-butanediol to 80° C. Next, one-half percent by weight of piperazine was added and thoroughly mixed with the 1,4-butanediol.

### EXAMPLE 4

### Preparation of the Polyurethane Composition Suitable for Rotational Casting

The substantially linear isocyanate-terminated polyester prepolymer prepared in Example 1 was rotationally cast with the curative agent prepared in Example 3 at a 98% stoichiometry as a free film and molded in metal molds and cured for 16 hours at 115° C. The flex fatigue resistance properties were then measured. The experimental results are summarized below in Table 1.

### EXAMPLE 5

### Preparation of the Polyurethane Composition Suitable for Rotational Casting

The substantially linear isocyanate-terminated polyester prepolymer prepared in Example 1 was rotationally cast with the curative agent prepared in Example 3 at 98% stoichiometry as a free film and molded in metal molds and then allowed to cure at ambient temperature. The flex fatigue resistance properties were then measured. The experimental results are summarized below in Table 1.

### EXAMPLE 6

### Preparation of the Polyurethane Composition Suitable for Rotational Casting

The substantially linear isocyanate-terminated polyether prepolymer prepared in Example 2 was rotationally cast with the curative agent prepared in Example 3 at 95% stoichiometry as a free film and molded in metal molds and cured for 16 hours at 70° C. The flex fatigue resistance properties were then measured. The experimental results are summarized below in Table 2.

### EXAMPLE 7

### Preparation of the Polyurethane Composition Suitable for Rotational Casting

The substantially linear isocyanate-terminated polyether prepolymer prepared in Example 2 was rotationally cast with the curative agent prepared in Example 3 at 103% stoichiometry as a free film and molded in metal molds and cured for 16 hours at 70° C. The flex fatigue resistance properties were then measured. The experimental results are summarized below in Table 2.

### EXAMPLE 8

### Preparation of the Polyurethane Composition Suitable for Rotational Casting

The substantially linear isocyanate-terminated polyether prepolymer prepared in Example 2 was rotationally cast with the curative agent prepared in Example 3 at 98% stoichiometry as a free film and molded in metal molds and cured for 16 hours at 115° C. The flex fatigue resistance properties were then measured. The experimental results are summarized below in Table 2.

### Comparative Example A

### Preparation of a Branched Polyurethane Composition for Hot Casting

A branched MDI polyester prepolymer formed by reacting 3.2 moles of MDI with 1 mole of PTMG polyol of 2.05 functionality of 1900 MW prepared from ethylene glycol, trimethylolpropane and adpic acid, for 5 hours at 105° C. employing the same equipment as in example 1. The resultant NCO was 6-7%. This prepolymer was hot cast with 1,4-butanediol at 98% stoichiometry into metal molds at 45° C. and postcured for 16 hours at 115° C. The flex fatigue resistance properties were then measured. The experimental results are summarized below in Table 1.

### Comparative Example B

### Preparation of a Branched Polyurethane Composition for Hot Casting

A branched MDI polyether prepolymer formed by reacting 3.25 moles of MDI with 1 mole of PTMG polyol at 2000 MW and 0.025 moles of trimethylolpropane for 2 hours at 80° C. employing the same equipment as in example 1. The resultant NCO was 6.5%. This prepolymer was hot cast with 1,4-butandiol at 95% stoichiometry into molds at 70° C. and cured for 16 hours at 70° C. The flex fatigue resistance properties were then measured. The experimental results are summarized below in Table 2.

### Comparative Example C

### Preparation of a Branched Polyurethane Composition for Hot Casting

A branched MDI polyether prepolymer formed by reacting 3.25 moles of MDI with 1 mole of PTMG polyol at 2000 MW and 0.025 moles of trimethylolpropane for 2 hours at 80° C. employing the same equipment as in Example 1. The resultant NCO was 6.5%. This prepolymer was hot cast with 1,4-butandiol at 100% stoichiometry into metal molds at 70° C. and cured for 16 hours at 70° C. The flex fatigue properties were then measured. The experimental results are summarized below in Table 2.

### Comparative Example D

### Preparation of a Branched Polyurethane Composition for Hot Casting

A branched MDI polyether prepolymer formed by reacting 3.25 moles of MDI with 1 mole of PTMG polyol at 2000 MW and 0.025 moles of trimethylolpropane for 2 hours at 80° C. employing the same equipment as in example 1. The resultant NCO was 6.5%. This prepolymer was hot cast with 1,4-butandiol at 105% stoichiometry into metal molds at 70° C. and cured for 16 hours at 70°. The flex fatigue resistance properties were then measured. The experimental results are summarized below in Table 2.

### Comparative Example E

### Preparation of a Polyurethane Composition Outside the Scope of this Invention for Rotational Casting

A polyurethane composition formed by reacting a polyether prepolymer component with a curative component. The prepolymer component was formed by reacting 3.2 moles of MDI with 1 mole of PTMG 2000 MW for 2 hours at 80° C. employing the same equipment as in example 1. The resultant NCO was 6.3%. The curative component was formed by blending PTMG polyol with a mixture of aromatic diamines diethyltoluene diamine and dimethylthiotoluene diamine such that the weight percent of the PTMG polyol was 60% and the mixture of aromatic diamines was 40%. The equivalent weight of the blend was 169. The prepolymer component and curative component were rotationally cast at 95% stoichiometry as free films and into metal molds and cured 16 hours at 70° C. The flex fatigue resistance property were then measured. The experimental results are summarized below in Table 2.

### Comparative Example F

### Preparation of a Polyurethane Composition Outside the Scope of this Invention for Rotational Casting

A polyurethane composition was formed by reacting a polyether prepolymer component with a curative component. The prepolymer component was formed by reacting 3.2 moles of MDI with 1 mole of PTMG 2000 MW for 2 hours at 80° C. employing the same equipment as in example 1. The resultant NCO was 6.3%. The curative component was formed by blending PTMG polyol with a mixture of aromatic diamines diethyltoluene diamine and dimethylthiotoluene diamine such that the weight percent of the PTMG polyol was 60% and the mixture of aromatic diamines was 40%. The equivalent weight of the blend was 169. The prepolymer component and curative component were rotationally cast at 100% stoichiometry as free forms and into metal molds and cured for 16 hours at 70° C. The flex fatigue resistance property were then measured. The experimental results are summarized below in Table 2.

### Comparative Example G

### Preparation of a Polyurethane Composition Outside the Scope of this Invention for Rotational Casting

A polyurethane composition was formed by reacting a polyether prepolymer component with a curative component. The prepolymer component was formed by reacting 3.2 moles of MDI with 1 mole of PTMG 2000 MW for 2 hours at 80° C. employing the same equipment as in example 1. The resultant NCO was 6.3%. The curative component was formed by blending PTMG polyol with a mixture of aromatic diamines diethyltoluene diamine and dimethylthiotoluene diamine such that the weight percent of the PTMG polyol was 60% and the mixture of aromatic diamines was 40%. The equivalent weight of the blend was 169. The prepolymer component and curative component were rotationally cast at 105% stoichiometry as free films and into metal molds and cured for 16 hours at 70° C. The flex fatigue resistance property were then measured. The experimental results are summarized below in Table 2.

### Comparative Example H

The substantially linear isocyanate-terminated polyester prepolymer prepared in example 1 was rotationally cast with PTMEG, a high molecular weight diol, as the curative agent at 100% stoichiometry as free films and into metal molds and cured for 16 hours at 100° C. The resulting material was rendered too soft to measure flex fatigue and therefore was deemed inoperable.

### Comparative Example I

The substantially linear isocyanate-terminated polyether prepolymer prepared in Example 2 was rotationally cast with PTMEG, a high molecular weight diol, as the curative agent at 100% stoichiometry as free films and into metal molds and cured for 16 hours at 100° C. The resulting material was rendered too soft to measure flex fatigue and therefore was deemed inoperable.

TABLE 1
Comparison of Polyurethane Composition Formed From
an Isocyanate-Terminated Polyester Prepolymer

| | STOICHIO- | CURE | SHORE | TEXUS FLEX. |
|---|---|---|---|---|
| SAMPLE | METRY | TEMP. (° C.) | A | CYCLES |
| Example 4 | 98 | 115 | 85 | 800 K |
| Example 5 | 98 | room temp. | 86 | 220 K |
| Comp. Ex. A | 98 | 115 | 85 | 100 K |

As these data show a material suitable for a flexible substrate possessing a coating formed from a polyurethane composition employing a substantially linear isocyanate-terminated polyester prepolymer and curative agent (within the scope of this invention), i.e., Examples 4 and 5, resulted in a significantly higher flex fatigue as compared to a material formed from a polyurethane composition employing a branched isocyanate-terminated polyester prepolymer and curative agent (outside the scope of this invention), i.e., Comparative Example A.

TABLE 2
Comparison of Polyurethane Compositions Formed From
an Isocyanate-Terminated Polyether Prepolymer

| | STOICHIO- | CURE | SHORE | TEXUS FLEX. |
|---|---|---|---|---|
| SAMPLE | METRY | TEMP. (° C.) | A | CYCLES |
| Example 6 | 95 | 70 | 90 | 25 K |
| Example 7 | 103 | 70 | 89 | 103 K |
| Example 8 | 98 | 115 | 90 | 12 K |
| Comp. Ex. B | 95 | 70 | 89 | 2 K |
| Comp. Ex. C | 100 | 70 | 88 | 5 K |
| Comp. Ex. D | 105 | 70 | 87 | 7 K |
| Comp. Ex. E | 95 | 70 | 90 | 3 K |
| Comp. Ex. F | 100 | 70 | 89 | 6 K |
| Comp. Ex. G | 105 | 70 | 88 | 40 K |

As these data show, a material suitable for a flexible substrate employing a substantially linear isocyanate-terminated polyether prepolymer and curative agent (within the scope of this invention), i.e., Examples 6-8, resulted in a significantly higher flex fatigue as compared to a material formed from a polyurethane composition employing a branched isocyanate-terminated polyether prepolymer and curative agent (outside the scope of this invention), i.e., Comparative Examples B, C and D. For example, when comparing Example 6 with Comparative Example B, both of which utilized identical stoichiometric amounts of prepolymer and curative agent, Example 6 shows a higher flex fatigue. Additionally, when comparing Example 7 with Comparative Examples C and D, Example 7 resulted in a significantly higher flex fatigue, i.e., 103K versus 5K and 7K, respectively. Also important to note is when employing a polyurethane composition formed from a substantially linear isocyanate-terminated polyurethane prepolymer and a high molecular weight diol curative agent (which is outside the scope of this invention), i.e., Comparative Examples H and I, the resulting coating was too soft and therefore inoperable.

What is claimed is:

1. A method for coating a flexible substrate which comprises rotationally casting to the substrate a coating comprising a polyurethane composition formed from (a) a substantially linear isocyanate-terminated polyurethane prepolymer; and, (b) a curative agent containing a diol having a molecular weight of less than about 250 and, optionally, a secondary aliphatic diamine, wherein the polyurethane composition is formed in the absence of a non-linear isocyanate-terminated polyurethane prepolymer.

2. The method of claim 1 wherein the flexible substrate is a fabric, a foam or a thin metal sheet.

3. The method of claim 2 wherein the fabric is selected from the group consisting of nylon, rayon, polyester, cotton, wool, kevlar and fiberglass.

4. The method of claim 2 wherein the foam is selected from the group consisting of polyurethane, polyethylene, vinyl polymer, rubber latex, nitrile and neoprene.

5. The method of claim 1 wherein the substantially linear isocyanate-terminated polyurethane prepolymer is a reaction product of a polyol and an organic diisocyanate monomer selected from the group consisting of 2,4-toluene diisocyanate, 2,6-toluene diisocyanate, 4,4′-diisocynatodiphenylmethane (MDI), p-henylenediisocyanate (PPDI), diphenyl-4,4′-diisocynate, 1,3-xylene diisocyanate, 1,4-xylene diisocyante, 1,6-hexamethylene diisocyanate, 1,3-cyclohexyl diisocyanate, 1,4-cyclohexyl diisocyanate (CHDI), diphenylmethane diisocyanate (H(12)MDI) and isophorone diisocyanate.

6. The method of claim 5 wherein the organic diisocyanate monomer is selected from the group consisting of MDI and PPDI.

7. The method of claim 1 wherein the substantially linear isocyanate-terminated polyurethane prepolymer is a reaction product of an organic diisocyanate monomer and a polyol selected from the group consisting of ethylene glycol, diethylene glycol, tetramethylene ether glycol, 1,2-propylene glycol, 1,3-propane diol, 1,4-butylene glycol, polytetramethylene ether glycol (PTMEG), polycarbonate and a dihydroxy polyester.

8. The method of claim 1 wherein the substantially linear isocyanate-terminated polyurethane prepolymer is a reaction product of an organic diisocyanate monomer and a dihydroxypolyester.

9. The method of claim 1 wherein the diol is selected from the group consisting of ethylene glycol, 1,2-propylene glycol, 1,3-propanediol, 1,3-butylene glycol, 1,4-butanediol, 2-methyl-1,3-propanediol, 1,5-pentanediol, neopentyl glycol, 1,6-hexanediol, 2-ethyl-2-propyl-1,3-propanediol, cyclohexyldimethanol, cyclohexanediol, hydroquinone di (betahydroxyethyl)ether, and resorcinor di(betahydroxy)ethyl ether.

10. The method of claim 1 wherein the substantially linear isocyanate-terminated polyurethane prepolymer is prepared by reacting an organic diisocyanate monomer with a polyol, in a mole ratio of organic diisocyanate monomer to polyol ranging from about 1.7:1 to about 12:1.

11. The method of claim 1 wherein the diol is mixed with the secondary aliphatic diamine in an amount ranging from about 95 to 100 weight percent based on the total weight of the diol and diamine.

12. The method of claim 1 further containing the secondary aliphatic diamine.

13. The method of claim 12 wherein the secondary aliphatic diamine is selected from the group consisting of dimethylethylenediamine and piperazine.

14. The method of claim 12 wherein the secondary aliphatic diamine is mixed with the diol in an amount ranging from about 0.25 to about 1 weight percent based on the total weight of the diamine and diol.

15. The method of claim 12 wherein the total active hydrogen content of the diol and secondary aliphatic diamine is equal to about 80-115% of the total isocyanate content of the isocyanate-terminated polyurethane prepolymer.

16. The method of claim 12 wherein the total active hydrogen content of the diol and secondary aliphatic diamine is equal to about 90-95% of the total isocyanate content of the isocyanate-terminated polyurethane prepolymer.

17. A flexible substrate possessing a coating, the coating comprising a polyurethane composition formed from (a) a substantially linear isocyanate-terminated polyurethane prepolymer; and, (b) a curative agent containing a diol having a molecular weight of less than about 250 and, optionally, a secondary aliphatic diamine, wherein the polyurethane composition is formed in the absence of a non-linear isocyanate-terminated polyurethane prepolymer.

18. The flexible substrate of claim 17 wherein the flexible substrate is a fabric, a foam or a thin metal sheet.

19. The flexible substrate of claim 18 wherein the fabric is selected from the group consisting of nylon, rayon, polyester, cotton, wool, kevlar and fiberglass.

20. The flexible substrate of claim 18 wherein the foam is selected from the group consisting of polyurethane, polyethylene, vinyl polymer, rubber latex, nitrile and neoprene.

21. The flexible substrate of claim 17 wherein the substantially linear isocyanate-terminated polyurethane prepolymer is a reaction product of a polyol and an organic diisocyanate monomer selected from the group consisting of 2,4-toluene diisocyanate, 2,6-toluene diisocyanate, 4,4′-diisocynatodiphenylmethane (MDI), p-phenylenediisocyanate (PPDI), diphenyl-4,4′-diisocyanate, 1,3-xylene diisocyanate, 1,4-xylene diisocyanate, 1,6-hexamethylene diisocyanate, 1,3-cyclohexyl diisocyanate, 1,4-cyclohexyl diisocyanate (CHDI), diphenylmethane diisocyanate (H(12)MDI) and isophorone diisocyanate.

22. The flexible substrate of claim 21 wherein the organic diisocyanate monomer is selected from the group consisting of MDI and PPDI.

23. The flexible substrate of claim 17 wherein the substantially linear isocyanate-terminated polyurethane prepolymer is a reaction product of an organic diisocyanate monomer and a polyol selected from the group consisting of ethylene glycol, diethylene glycol, tetramethylene ether glycol, 1,2-propylene glycol, 1,3-propane diol, 1,4-butylene glycol, polytetramethylene ether glycol (PTMEG), polycarbonate and a dihydroxypolyester.

24. The flexible substrate of claim 23 wherein the substantially linear isocyanate-terminated polyurethane prepolymer is a reaction product of an organic diisocyanate monomer and a dihydroxypolyester.

25. The flexible substrate of claim 17 wherein the substantially linear isocyanate-terminated polyurethane prepolymer is prepared by reacting an organic diisocyanate monomer with a polyol, in a mole ratio of organic diisocyanate monomer to polyol ranging from about 1.7:1 to about 12:1.

26. The flexible substrate of claim 17 wherein the diol is selected from the group consisting of ethylene glycol, 1,2-propylene glycol, 1,3-propanediol, 1,3-butylene glycol, 1,4-butanediol, 2-methyl-1,3-propanediol, 1,5-pentanediol, neopentyl glycol, 1,6-hexanediol, 2-ethyl-2-propyl-1,3-propanediol, cyclohexyldimethanol, cyclohexanediol, hydroquinone di(betahydroxyethyl)ether, and resorcinor di (betahydroxy)ethyl ether.

27. The flexible substrate of claim 17 wherein the diol is mixed with the secondary aliphatic diamine in an amount ranging from about 95 to 100 weight percent based on the total weight of diol and diamine.

28. The flexible substrate of claim 17 further containing the secondary aliphatic diamine.

29. The flexible substrate of claim 28 wherein the secondary aliphatic diamine is selected from the group consisting of dimethylethylenediamine and piperazine.

30. The flexible substrate of claim 28 wherein the secondary aliphatic diamine is mixed with the diol in an amount ranging from about 0.25 to about 1 weight percent based on the total weight of diamine and diol.

31. The flexible substrate of claim 28 wherein the total active hydrogen content of the diol and secondary aliphatic diamine is equal to about 80-115% of the total isocyanate content of the isocyanate-terminated polyurethane prepolymer.

32. The flexible substrate of claim 28 wherein the total active hydrogen content of the diol and secondary aliphatic diamine is equal to about 90-95% of the total isocyanate content of the isocyanate-terminated polyurethane prepolymer.

33. A flexible substrate possessing a coating, the coating exhibiting a flex fatigue resistance of from about 25,000 to about 2,000,000, the coating consisting essentially of a polyurethane composition formed from (a) a substantially linear isocyanate-terminated polyurethane prepolymer; and, (b) a curative agent containing a diol having a molecular weight of less than about 250, and, optionally, a secondary aliphatic diamine.

34. The flexible substrate of claim 33 wherein the substantially linear isocyanate-terminated polyurethane prepolymer is a reaction product of a polyol selected from the group consisting of ethylene glycol, diethylene glycol, tetramethylene ether glycol, 1,2-propylene glycol, 1,3-propane diol, 1,4-butylene glycol, polytetramethylene ether glycol (PTMEG), polycarbonate and a dihydroxypolyester and an organic diisocyanate monomer selected from the group consisting of 2,4-toluene diisocyanate, 2,6-toluene diisocyanate, 4,4′-diisocynatodiphenylmethane (MDI), p-phenylenediisocyanate (PPDI), diphenyl-4,4′-diisocyanate, 1,3-xylene diisocyanate, 1,4-xylene diiosocyante, 1,6-hexamethylene diisocyanate, 1,3-cyclohexyl diisocyanate, 1,4-cyclohexyl diisocyanate (CHDI), diphenylmethane diisocyanate (H(12)MDI) and isophorone diisocyanate.

35. The flexible substrate of claim 33 wherein the substantially linear isocyanate-terminated polyurethane prepolymer is prepared by reacting an organic diisocyanate monomer with a polyol, in a mole ratio of organic diisocyanate monomer to polyol ranging from about 1.7:1 to about 12:1.

36. The flexible substrate of claim 33 wherein the diol is selected from the group consisting of ethylene glycol, 1,2-propylene glycol, 1,3-propanediol, 1,3-butylene glycol, 1,4-butanediol, 2-methyl-1,3-propanediol, 1,5-pentanediol, neopentyl glycol, 1,6-hexanediol, 2-ethyl-2-propyl-1,3-propanediol, cyclohexyldimethanol, cyclohexanediol, hydroquinone di (betahydroxyethyl)ether, resorcinor di(betahydroxy)ethyl ether.

37. The flexible substrate of claim 33 wherein the diol is mixed with the secondary aliphatic diamine in an amount ranging from about 95 to 100 weight percent based on the total weight of diol and diamine.

38. The flexible substrate of claim 33 further containing the secondary aliphatic diamine.

39. The flexible substrate of claim 38 wherein the secondary aliphatic diamine is selected from the group consisting of dimethylethylenediamine and piperazine.

40. The flexible substrate of claim 38 wherein the secondary aliphatic diamine is mixed with the diol in an amount ranging from about 0.25 to about 1 weight percent based on the total weight of diamine and diol.
